(19) United States
(12) Patent Application Publication
(10) Pub. No.: US 2005/0050139 A1
(43) Pub. Date: Mar. 3, 2005

(54) Parametric-based control of autonomic architecture

(75) Inventors: Thomas E. Creamer, Boca Raton, FL (US); Bill H. Hilf, La Habra, CA (US); Neil A. Katz, Parkland, FL (US); Victor S. Moore, Boynton Beach, FL (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/654,360

(22) Filed: Sep. 3, 2003

(51) Int. Cl. G06F 15/16

(52) U.S. Cl. 709/200

(57) ABSTRACT

A method of handling requests can include the step of handling requests with a handler. An overload condition can be detected for said handler. Requests can be directed to an alternative handler. A return timer can be initialized. When the return timer exceeds a time threshold for the alternative handler, requests can be routed to the handler. The time threshold can be automatically adjusted based upon a time in which the handler handles requests.

### BACKGROUND

1. Field of the Invention

The present invention relates to the field of self-adjusting computing systems and, more particularly, to self-adjusting systems that include a plurality of request handlers.

2. Description of the Related Art

The concept of autonomic computing has been developed to address the problem of managing complexity within computing systems. Autonomic computing is a self-managing computing model named after, and patterned on, the human body's autonomic nervous system. An ideal autonomic computing system can control the functioning of computer applications and systems without input from the user, in the same way that the autonomic nervous system regulates body systems without conscious input from the individual.

One of the challenges in establishing an autonomic system or any self-governing architecture is automatically selecting request handlers from a multitude of different handlers, each of which is capable of handling a given request. For example, a particular handler can have several equivalent and redundant counterparts that add flexibility and capacity to the overall autonomic system. It should be noted that some request handlers, which are capable of responding to requests, can be operationally preferred over other handlers. For example, one handler can respond to information requests utilizing a source database disposed within a network, while another handler can respond to information requests utilizing a local copy of the source database. In the example, while both the first and second handlers can provide request responses, the first handler can be preferred over the second handler.

Conventionally, the routing of requests to different handlers has involved a series of predefined usage thresholds. Whenever a usage of a primary handler exceeds one of the usage thresholds, requests are directed to an alternative handler. Unfortunately, if a given system condition oscillates near a threshold, the autonomic system can repetitively fluctuate between two or more handlers. This fluctuating behavior can result in inefficient request handling.

One conventional solution to the handler oscillation problem involves averaging usage input values. By averaging values, the influence of short usage spikes and slight usage lulls within an autonomic system can be managed routinely with a minimum amount of overcompensation by the request management system. Another similar solution requires a threshold to be exceeded a predefined number of times before a system adjustment is performed. While these traditional solutions provide some relief to the problem of a vacillating autonomic system, the solutions are not sophisticated enough to handle the myriad of complexities involved in a multifarious system, such as a distributed autonomic computer system. As such, more robust solutions are needed.

### SUMMARY OF THE INVENTION

The present invention provides a method, a system, and an apparatus to establish parametric based controls within an autonomic architecture. The invention assumes an environment where a self-governing engine can direct requests to one of a variety of different request handlers. In one embodiment, the environment can include an autonomic application server that routes requests to different request handlers based on handler usage levels. In another embodiment, the environment can include a Web architecture with redundant request handling components, where requests can be routed to those components with available capacity. The application is not, however, limited to any particular environment and can be generally utilized in conjunction with any architecture capable of automatically routing requests based upon variable system states.

More specifically, the invention can begin whenever an overload condition is determined. The overload condition can cause requests to be routed from a primary request handler to an alternative request handler. The alternative request handler can handle requests for a predetermined period. Once the predetermined period expires, requests can be once again handled by the primary request handler.

Additionally, the invention can automatically adjust the period for using the alternative handler to assure that the invention does not oscillate between the primary request handler and the alternative request handler more than necessary. For example, if a usage threshold is exceeded shortly after requests are routed to the primary request handler, it can be assumed that the condition that originally caused the usage threshold to be exceeded still exists. Therefore, requests should be directed to the alternative request handler for a longer period. Accordingly, the predetermined period in which the alternative handler handles requests can be increased.

Further, the invention can automatically adjust the predetermined period to assure that requests are not directed to the alternative handler longer than is necessary. For example, if the primary handler is used for a long period before an overload condition is detected, it can be assumed that an overload condition rarely occurs and can the overload condition can be quickly resolved. Accordingly, the predetermined period for using the alternative handler can be decreased. Appreciably, the present invention is not limited to two handlers and can be instead applied to environments in which any number of handlers can receive requests.

One aspect of the present invention can include a method of handling requests that includes the step of handling requests with a handler. An overload condition can be detected for the handler. Responsive to the overload condition, requests can be directed to an alternative handler. A return timer can then be initialized for the alternative handler. When the return timer exceeds a time threshold for the alternative handler, requests can be routed from the alternative handler to the original handler. The time threshold can be automatically adjusted based upon a time in which the original handler handles requests. The requests handled by the original handler and the alternative handler can include Web requests. The original handler and the alternative handler can also be components of an application server. Moreover, the original handler and alternative handler can be components within an autonomic system.

In one embodiment, a handler timer can be started to calculate the time in which the original handler handles requests. A lower handler threshold and an upper handler threshold can be established. The time threshold for the alternative handler can be increased if the handler timer is less than the lower handler threshold when the overload condition is detected. The timer threshold for the alternative handler can be decreased if the handler timer is greater than the upper handler threshold when the overload condition is detected. Additionally, a minimum limit and a maximum limit can be established for the time threshold. Further, the time increment can be established for the time threshold of the alternative handler before the overload condition is detected. The time threshold can be increased by the time increment after the overload condition is detected based upon the time in which the original handler handles requests. A time decrement can also be established for the time threshold before the overload condition is detected. The time threshold can be decreased by the time decrement after the overload condition is detected based upon the time in which the original handler handles requests.

In another embodiment, an overload condition can be detected for the alternative handler. Responsive to this overload condition, requests can be directed from the alternative handler to another alternative handler. Another return timer can be started. When this other return timer exceeds a time threshold for this other alternative handler, requests can be routed to the original handler. The time threshold for this other alternative handler can be automatically adjusted based upon a time in which the alternative handler handles requests.

Another aspect of the present invention can include an autonomic system for serving applications. The system can include an application server, a status hub, and a handler selector. The application server can receive client requests and can selectively provide server responses to the client requests. The status hub can receive usage messages and can responsively publish system status messages. The handler selector can automatically select a handler from among a multitude of handlers based upon the system status messages. The handler selector can directs requests from a primary handler to a secondary handler if a system status message for the primary handler indicates an overload condition.

The handler selector can further include a return timer, a timer threshold for the secondary handler and a handler timer. The return timer can be initialized when requests are routed to the secondary handler. The handler selector can redirect requests to the primary handler when the return timer exceeds the time threshold. The handler timer can calculate a time in which the primary handler handles requests. The time threshold can be automatically adjusted based upon the handler timer.

In one embodiment, the handler selector can direct requests from the secondary handler to a tertiary handler if a system status message for the secondary handler indicates an overload condition. The handler selector can include another return timer that is initialized when requests are routed to the tertiary handler. A timer threshold for the tertiary handler can also be included in the handler selector. The handler selector can redirect requests to the primary handler from the tertiary handler when this other return timer exceeds the time threshold for the tertiary handler.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating an exemplary system for serving applications using parametrically controlled handlers in accordance with the inventive arrangements disclosed herein.

FIG. 2 is a schematic diagram illustrating self-adjusting parametric controls for handling requests according to the inventive arrangements detailed herein.

FIG. 3 is a flow chart of a method for routing requests within an autonomic architecture using parametric-based controls in accordance with the inventive arrangements disclosed herein.

### DETAILED DESCRIPTION OF THE INVENTION

The present invention can include a system, a method, and an apparatus for implementing parametric based controls to handle requests within an autonomic architecture. More specifically, an overload condition can cause requests to be routed from a primary request handler to a secondary request handler. A return timer can be initialized when the overload condition is detected. Whenever the return timer exceeds a time threshold for the secondary handler, requests can be routed from the secondary handler back to the primary handler. The time threshold for the secondary handler can be automatically adjusted based upon the time in which the primary handler handles requests before an overload condition is detected. For example, if the time requests are handled by the primary handler is less than a lower threshold, the time threshold for the secondary handler can be increased. Moreover, if the time requests are handled by the primary handler is greater than an upper threshold, the time threshold for the secondary handler can be decreased.

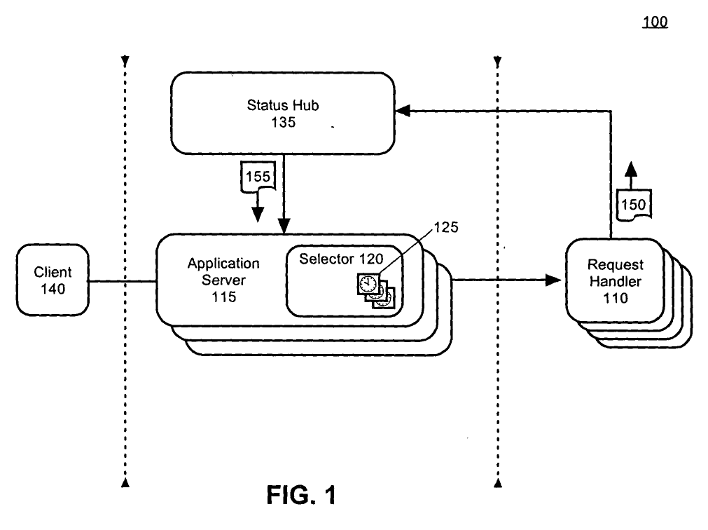

FIG. 1 is a schematic diagram illustrating an autonomic system 100 for serving applications using self-adjusting parametric controls according to the inventive arrangements detailed herein. The system 100 can include one or more request handlers 110, one or more application servers 115, and a status hub 135.

The request handler 110 can include any finite hardware and/or software resource used to handle a request for the application server 115. The request handler 110 can be a networked resource or local resource. Each request handler 110 can have limited capacity and can therefore be overloaded. An overloaded request handler 110 can result in request processing bottlenecks.

More specifically, each request handler 110 can be a computing service and/or computing application including, but not limited to, a directory service, a data management system, a text-to-speech application, a speech recognition application, a translation service, a transcription service, a Web service, and the like. At least a portion of the request handlers 110 can include one or more software resources, such as a process instance, an application instance, a software library, a software object, and/or software routine. Additionally, a portion of the request handlers 110 can include one or more hardware resources, such as a permanent storage, a memory, processing cycles of a processor, a shared peripheral, and the like.

The status hub 135 can receive usage messages 150 from the application handlers 110 and responsively publish system status messages 155. A system status message can indicate that an application handler 110 is in an overload state. The status hub 135 can include a variety of different hardware and/or software elements depending on the manner in which it is implemented. For example, the status hub 135 can be a series of instructions embedded within a network router and/or hub. Alternatively, the status hub 135 can be a software object and/or software application disposed within a connected computing system.

The application server 115 can receive system status messages 155 and client requests and selectively respond to the request based on the system status messages 155. Accordingly, if one request handler 110 is overloaded, a different request handler 110 can be used in its stead. The application server 115 can include a request selector 120.

The request selector 120 can include using a variety of timers 125, thresholds, and limits. Further, the request selector 120 can establish an order of preference among a plurality of request handlers 110. For example, for a particular request, a primary handler, secondary handler, tertiary handler, and the like can be identified. Each time a system status message 155 indicates a preferred request handler 110 is overloaded, incoming requests can be diverted to the next most preferred handler. This next most preferred handler can respond to requests for an established period. Once the established period lapses for the next most preferred handler, requests can again be routed to the preferred handler.

The established period can be automatically adjusted using the timers 125, thresholds, and limits so that requests are handled by alternative handlers for durations sufficient to resolve the overload condition. Additionally, adjustments can be made to assure that alternative handlers are used no longer than necessary.

In operation, a client 140 can convey a client request, such as an HTTP request, across a network the appropriate application server 115. The application server 115 can receive at least one system status message 155 from the status hub 135. The application server 115 can then categorize the client request. The client request category can be inputted into the request selector 120. The request selector 120 can use the request category to determine an order of preference among request handlers 110 for handing the client request. The most preferred handler that is not overloaded can be used to respond to the client request. For example, system status messages 155 can indicate that a primary handler is in an overload state and that secondary handler is available for requests. Accordingly, the client request can be conveyed to the secondary handler.

The request handlers 110 can submit usage messages 150 to the status hub 135. The status hub 135 can receive the usage messages 150 and determine the present status for the request handlers 110. The status hub 135 can convey system status messages 155 including status level indicators for request handlers 110 to the application servers 115.

It should be noted that the invention is not limited to any particular autonomic system, such as system 100, but can be generally applied to any self-governing system that includes at least two request handlers. Further, although the request selector 120 of system 100 can contain the limits, timers 125, and parameters as described above, the adjustment variables can be otherwise distributed in system 100. For example, the status hub 135 can delay transmitting system status messages 155 that indicate an overload condition has passed. The delay within the status hub 135 can be equivalent to the time that requests are to be handled by alternative handlers. Once the delay ends and the status hub 135 indicates that an overload condition has passed, the application servers 115 can immediately direct requests to the primary handler. Consequently, in such an example, the application server 115 would not need to track the time that alternative handlers handle requests.

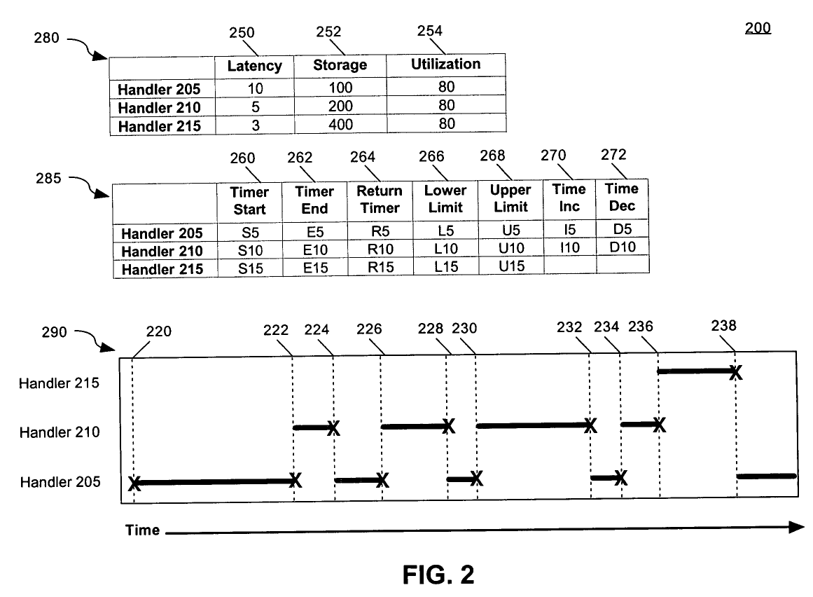

FIG. 2 is a schematic diagram illustrating a system 200 for using self-adjusting parametric controls for handling requests according to the inventive arrangements disclosed herein. System 200 includes a usage table 280, a timing table 285, and a request-handling chart 290. The usage table 280 can be utilized to determine whether a handler 205 is in an overloaded state or not. The usage table 280 can include rows for request handlers 205, 210, and 215, where handler 205 is a primary handler, handler 210 is a secondary handler, and handler 215 is a tertiary handler. Accordingly, the preferred order for handling requests can be handler 205, handler 210, and handler 215 respectively.

The usage table 280 can also include columns for various usage thresholds, such as latency 250, storage 252, and utilization 254. Various usage messages can be compared against the usage threshold to determine if an overload condition exists. For example, if a usage message indicates that the latency 250 for handler 205 exceeds 10 seconds, handler 205 can be overloaded. Similarly, if the latency 250 for handler 210 exceeds 5 seconds, handler 210 can be in an overloaded state. In another example, if the storage 252 for handler 210 exceeds 200 Mbytes, handler 210 can be overloaded. In yet another example, if the utilization 254 of handler 215 is over 80 percent, handler 215 can be overloaded.

The timing table 285 can be used to perform automatic timing adjustments. The timing table 285 can include rows for request handlers 205, 210, and 215. Additionally, the timing table 285 can include columns for various times such as, the timer start 260, timer end 262, return timer 264, lower limit 266, upper limit 268, time increment 270, and time decrement 272.

The timer start 260 can represent the point at which a particular handler begins handling requests. The timer end 262 can represent the point at which a particular handler stops handling requests. The return timer 264 can represent a duration that an alternate timer handles requests before requests are redirected to a primary handler. The lower limit 266 can represent an absolute minimum time that an alternative handler can handles requests. The lower limit 266 can also represent a minimum recommended time spent within a primary handler before the return timer 264 for an alternative handler should be increased. The upper limit 268 can represent an absolute maximum time that an alternative handler can handles requests. The upper limit 268 can also represent a maximum recommended time spent within a primary handler before the return timer 264 for an alternative handler should be decreased. The time increment 270 can represent a period used to increase the return timer 264 for the next most preferred handler. The time decrement 272 can represent a period used to decrease the return timer 264 for the next most preferred handler.

Chart 290 illustrates the distribution of request handled by handlers 205, 210, and 215 over time. For example, from time 220 to time 222, requests are directed to handler 205. As illustrated, requests are handled by hander 205 betweens times 220 and 222, between times 224 and 226, between times 228 and 230, between times 232 and 234, and from time 238 to the time at the end of the chart 290. Requests are handled by handler 210 between times 222 and 224, between times 226 and 228, between times 230 and 232, and between times 234 and 236. Finally, requests are handled by handler 215 between times 236 and 238.

In operation, handler 205 can respond to messages until time 222. At time 222 an overload condition for handler 205 occurs. The usage table 280 can be compared to various usage messages to determine the overload condition. For example, a usage message for handler 205 can indicate a latency 250 greater than 10 seconds, can indicate a storage requirement 252 exceeding 100 Mbytes, and/or can indicate a utilization 254 exceeding 80 percent. Once the overload condition occurs at time 222, incoming requests can be directed to handler 210. The time handler 210 begins handling request can be recorded as value S10 in table 285. A timer can be initiated for the handler 210 at time 222. When the timer equals or exceeds value R10, which is the return timer 264 value recorded for handler 210 in table 285, requests can be directed to handler 205. The start time for handler 205 can be recorded at value S5 in table 285.

At time 226, an overload condition can again be detected for handler 205. Accordingly, time 226 can be recorded as value E5 in table 385 and requests can be directed to handler 210. The period between time 224 and time 226, however, can be less than L5, which is the lower limit 366 value recorded for handler 205 in table 285. As a result, the value of R10 can be increased by 15, which is the time increment 270 value recorded for handler 205 in table 285. At time 228, the time in which requests are handled by handler 210 can be equal to or exceed R10. Therefore, requests can be routed to handler 205.

At time 230, it can be determined that handler 205 is in an overload state and requests can be routed to handler 210. Again, the period that handler 205 operated can be less than the L5 value. According, value R10 can be increased by the value of 15, as indicated by table 285. At time 232, the period indicated by R10 can expires and requests can again be directed to handler 205. At time 234, an overload condition can be detected and requests can be routed to handler 210. Again, R10 can be increased by 15 since the period that handler 205 operated is less than L5. At time 236, an overload condition can be determined for handler 210. That is, at least one of the latency 250, the storage 252, and the utilization 254 thresholds for handler 210 recorded in table 280 can be exceeded.

At time 236, requests can be directed to handler 215. At time 238, the time that handler 215 handles request can equal or can exceed R15, which is the return timer 264 value recorded for handler 215 in table 285. Accordingly, requests can be directed from handler 215 to handler 205 at time 238.

One of ordinary skill in the art can appreciate that FIG. 2 is just one of many illustrative examples of the present invention and that the invention should not be construed as being limited to the details expressed within the example. For example, the tables 280 and 285 need not be implemented as tables, but can be implemented as a series of variables that have been allocated memory for temporarily storing parameters. Further, any variety of usage thresholds can be used in the present invention. Latency, storage, and utilization are merely common usage thresholds used herein for illustrative purposes only. Likewise, any of a variety of suitable time thresholds can be substituted for those of table 285 so long as the thresholds allow the request handling to be adjusted in the manner described herein.

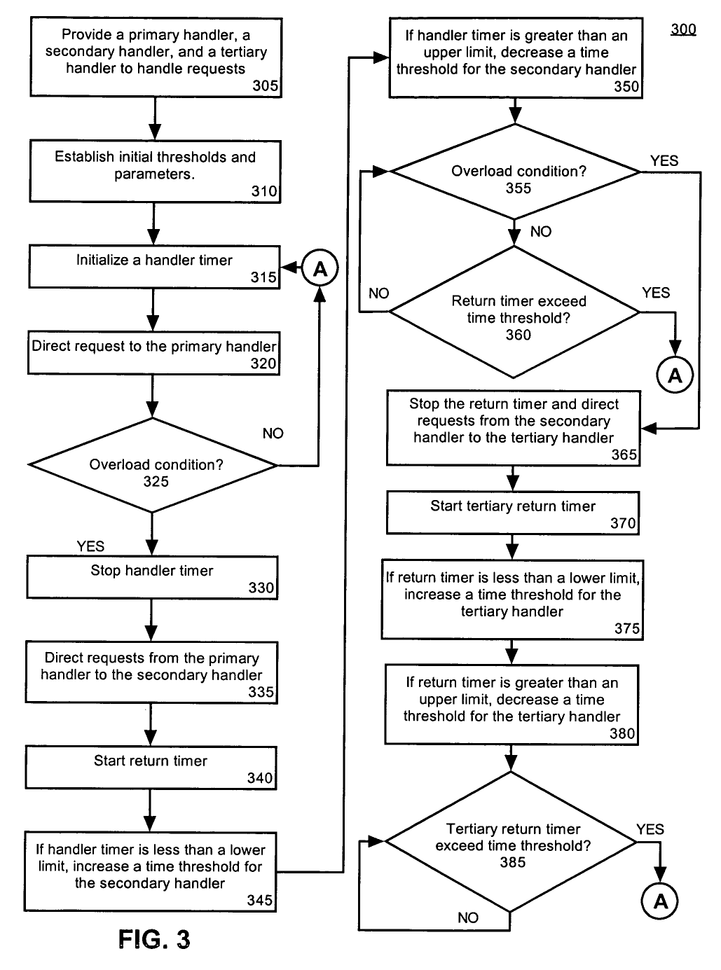

FIG. 3 is a flow chart of a method 300 for routing requests within an autonomic architecture using parametric-based controls in accordance with the inventive arrangements disclosed herein. The method 300 can be performed within the context of a self-governing system that receives one or more requests. The method 300 can begin in step 305, where a primary handler, a secondary handler, and a tertiary handler can be provided to handle requests. In step 310, initial thresholds and parameters for can be established. For example, usage thresholds, return thresholds, lower time limits, upper time limits, time increments, time decrements, and the like can be established for each of the three handlers as appropriate. The usage threshold can be used to determine if an associated handler is in an overload state.

In step 315, a handler timer can be initialized for the primary handler. In step 320, requests can be directed to the primary handler. In step 325, a determination can be made as to whether an overload condition exists for the primary handler. If not, the method can proceed to step 315. If so, the method can proceed to step 330, where the handler timer can be stopped. Then, in step 335, requests can be directed from the primary handler to the secondary handler. In step 340, a return timer can be started. In step 345, if the handler timer value is less than a lower time limit for the primary handler, a time threshold for the secondary handler can be increased. In step 350, if the handler timer value is greater than an upper time limit for the primary handler, a time threshold for the secondary handler can be decreased. There can be both minimum and maximum limits for adjusting the time threshold for the secondary handler.

In step 355, a determination can be made as to whether an overload condition exists for the secondary handler. If not, then the method can proceed to step 360, where a determination can be made as to whether the return timer exceeds the time threshold for the secondary handler. If the time threshold is exceeded in step 360, the method can proceed to step 315, where the handler timer can be initiated and requests can be directed from the secondary handler to the primary handler. If the time threshold is not exceeded in step 360, then the method can proceed to step 355, where a determination can again be made concerning an overload condition for the secondary handler.

If an overload condition is determined for the secondary handler in step 355, however, the method can proceed to step 365. In step 365, the return timer can be stopped and requests can be directed from the secondary handler to the tertiary handler. In step 370, a tertiary return timer can be started. In step 375, if the return timer value is less than a lower time limit for the secondary handler, a time threshold for the tertiary handler can be increased. In step 380, if the return timer value is greater than an upper time limit for the secondary handler, a time threshold for the tertiary handler can be decreased. In step 385, if the tertiary return timer does not exceed the time threshold for the tertiary handler, the tertiary handler can continue to handle requests. If, however, the tertiary return time exceeds the time threshold for the tertiary timer, the method can proceed to step 315. In step 315, the handler timer can be initialized and requests can be directed from the tertiary handler to the primary handler.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method of handling requests comprising the steps of:
handling requests with a handler;
detecting an overload condition for said handler;
directing requests to an alternative handler;
initializing a return timer;
when said return timer exceeds a time threshold for said alternative handler, routing requests to said handler; and
automatically adjusting said time threshold based upon a period using said handler.

2. The method of claim 1, further comprising the steps of:
starting a handler timer to calculate said time in which said handler handles requests;
establishing a lower handler threshold; and
establishing an upper handler threshold.

3. The method of claim 2, further comprising the step of:
increasing said time threshold if said handler timer is less than said lower handler threshold when said overload condition is detected.

4. The method of claim 2, further comprising the step of:
decreasing said time threshold if said handler timer is greater than said upper handler threshold when said overload condition is detected.

5. The method of claim 1, further comprising the steps of:
establishing a minimum limit for said time threshold; and
establishing a maximum limit for said time threshold.

6. The method of claim 1, further comprising the steps of:
establishing a time increment for said time threshold before said overload condition is detected; and
increasing said time threshold by said time increment after said overload condition is detected based upon said time in which said handler handles requests.

7. The method of claim 1, further comprising the steps of:
establishing a time decrement for said time threshold before said overload condition is detected; and
decreasing said time threshold by said time decrement after said overload condition is detected based upon said time in which said handler handles requests.

8. The method of claim 1, further comprising the steps of:
detecting an overload condition for said alternative handler;
directing requests to another alternative handler;
starting another return timer; and
when said another return timer exceeds a time threshold for said another alternative handler, routing requests to said handler.

9. The method of claim 8, further comprising the step of:
automatically adjusting said time threshold for said another alternative handler based upon a period using said alternative handler.

10. The method of claim 1, wherein said requests handled by said handler and said alternative handler comprise Web requests.

11. The method of claim 1, wherein said handler and said alternative handler are components of an application server.

12. The method of claim 1, wherein said handler and said alternative handler are components within an autonomic system.

13. An autonomic system for serving applications comprising:
an application server configured to receive client requests and configured to selectively provide server responses to said client requests;
a status hub configured to receive usage messages and responsively publish system status messages; and
a handler selector configured to automatically select a handler from among a plurality of handlers based upon said system status messages, wherein said handler selector directs requests from a primary handler to a secondary handler if a system status message for said primary handler indicates an overload condition.

14. The system of claim 13, said handler selector further comprising:
a return timer that is initialized when requests are routed to said secondary handler; and
a timer threshold for said secondary handler, wherein said handler selector redirects requests to said primary handler when said return timer exceeds said time threshold.

15. The system of claim 14, said handler selector further comprising:
a handler timer used to calculate a time in which said primary handler handles requests, wherein said time threshold is automatically adjusted based upon said handler timer.

16. The system of claim 13, wherein said handler selector directs requests from said secondary handler to a tertiary handler if a system status message for said secondary handler indicates an overload condition.

17. The system of claim 16, said handler selector further comprising:
another return timer that is initialized when requests are routed to said tertiary handler; and
a timer threshold for said tertiary handler, wherein said handler selector redirects requests to said primary handler from said tertiary handler when said another return timer exceeds said time threshold for said tertiary handler.

18. A machine-readable storage having stored thereon, a computer program having a plurality of code sections, said code sections executable by a machine for causing the machine to perform the steps of:
handling requests with a handler;
detecting an overload condition for said handler;
directing requests to an alternative handler;
initializing a return timer;
when said return timer exceeds a time threshold for said alternative handler, routing requests to said handler; and
automatically adjusting said time threshold based upon a period using said handler.

19. The machine-readable storage of claim 18, further comprising the steps of:
starting a handler timer to calculate said time in which said handler handles requests;
establishing a lower handler threshold; and
establishing an upper handler threshold.

20. The machine-readable storage of claim 19, further comprising the step of:
increasing said time threshold if said handler timer is less than said lower handler threshold when said overload condition is detected.

21. The machine-readable storage of claim 19, further comprising the step of:
decreasing said time threshold if said handler timer is greater than said upper handler threshold when said overload condition is detected.

22. The machine-readable storage of claim 18, further comprising the steps of:
establishing a minimum limit for said time threshold; and
establishing a maximum limit for said time threshold.

23. The machine-readable storage of claim 18, further comprising the steps of:
establishing a time increment for said time threshold before said overload condition is detected; and
increasing said time threshold by said time increment after said overload condition is detected based upon said time in which said handler handles requests.

24. The machine-readable storage of claim 18, further comprising the steps of:
establishing a time decrement for said time threshold before said overload condition is detected; and
decreasing said time threshold by said time decrement after said overload condition is detected based upon said time in which said handler handles requests.

25. The machine-readable storage of claim 18, further comprising the steps of:
detecting an overload condition for said alternative handler;
directing requests to another alternative handler;
starting another return timer; and
when said another return timer exceeds a time threshold for said another alternative handler, routing requests to said handler.

26. The machine-readable storage of claim 25, further comprising the step of:
automatically adjusting said time threshold for said another alternative handler based upon a period using said alternative handler.

27. The machine-readable storage of claim 18, wherein said requests handled by said handler and said alternative handler comprise Web requests.

28. The machine-readable storage of claim 18, wherein said handler and said alternative handler are components of an application server.

29. The machine-readable storage of claim 18, wherein said handler and said alternative handler are components within an autonomic system.

30. A system of handling requests comprising the steps of:
means for handling requests with a handler;
means for detecting an overload condition for said handler;
means for directing requests to an alternative handler;
means for initialing a return timer;
means for routing requests to said handler when said return timer exceeds a time threshold for said alternative handler; and
means for automatically adjusting said time threshold based upon a period using said handler.
